(19) United States
(12) Patent Application Publication
(10) Pub. No.: US 2019/0079697 A1
(43) Pub. Date: Mar. 14, 2019

(54) STORAGE DEVICE

(71) Applicant: Toshiba Memory Corporation, Tokyo (JP)

(72) Inventors: Satoru SUZUKI, Yokohama Kanagawa (JP); Tamotsu KOZUKA, Yokohama Kanagawa (JP); Kaoru ABIKO, Kawasaki Kanagawa (JP)

(21) Appl. No.: 15/904,293

(22) Filed: Feb. 23, 2018

(30) Foreign Application Priority Data
Sep. 12, 2017 (JP) 2017-174930

(51) Int. Cl. G06F 3/06; G06F 13/10

(52) U.S. Cl. CPC G06F 3/0659; G06F 13/102; G06F 3/0673; G06F 3/0613

(57) ABSTRACT

A storage device includes a command reception unit and a control unit. The command reception unit is configured for communication with a host device to receive a command from the host device, and transmit a completion report to the host device upon completion of processing requested in the command. The control unit is configured to determine a threshold amount of time to wait after the command reception unit receives the command before causing the command reception unit to transmit the completion report, and to cause the command reception unit to transmit the completion report after waiting a period of time after completion of the processing, if the processing completes before the threshold amount of time has elapsed since reception of the command.

### CROSS-REFERENCE TO RELATED APPLICATION

This application is based upon and claims the benefit of priority from Japanese Patent Application No. 2017-174930, filed Sep. 12, 2017, the entire contents of which are incorporated herein by reference.

### FIELD

Embodiments described herein relate generally to a storage device.

### BACKGROUND

A storage device such as a solid state drive (SSD) is known. The storage device may have a large variation in latency with respect to a host device.

### DESCRIPTION OF THE DRAWINGS

FIG. 1 is a diagram illustrating an example of a host device and a storage device according to a first embodiment.

FIG. 2 is a diagram illustrating an example of a flow of command processing according to the first embodiment.

FIG. 3 is a diagram illustrating an example of a command reception unit, a time measurement unit, and a latency controller according to the first embodiment.

FIG. 4 is a flowchart illustrating an example of a flow of threshold value setting processing according to the first embodiment.

FIG. 5 is a flowchart illustrating an example of a flow of processing of a storage device accompanied by latency adjustment according to the first embodiment.

FIG. 6 is a diagram illustrating an example of a read operation of the storage device according to the first embodiment.

FIG. 7 is a diagram illustrating an example of a write operation of the storage device of the first embodiment.

FIG. 8 is a diagram illustrating an example of a command reception unit, a time measurement unit, and a latency controller according to a second embodiment.

FIG. 9 is a flowchart illustrating an example of a flow of threshold value setting processing according to the second embodiment.

### DETAILED DESCRIPTION

Embodiments provide a storage device capable of reducing variation in latency with respect to a host device.

In general, according to one embodiment, a storage device includes a command reception unit and a control unit. The command reception unit is configured for communication with a host device to receive a command from the host device, and transmit a completion report to the host device upon completion of processing requested in the command. The control unit is configured to determine a threshold amount of time to wait after the command reception unit receives the command before causing the command reception unit to transmit the completion report, and to cause the command reception unit to transmit the completion report after waiting a period of time after completion of the processing, if the processing completes before the threshold amount of time has elapsed since reception of the command.

Hereinafter, a storage device of an embodiment will be described with reference to the drawings. In the following description, configurations having the same or similar functions are given the same reference numerals. Redundant description may be omitted in some cases. The expression “based on XX” in the present specification means “based on at least XX”, and also includes a case which is based on another element in addition to XX. The expression “based on XX” is not limited to a case where XX is directly used, but also includes a case which is based on matters that an operation or processing is performed with respect to XX.

### First Embodiment

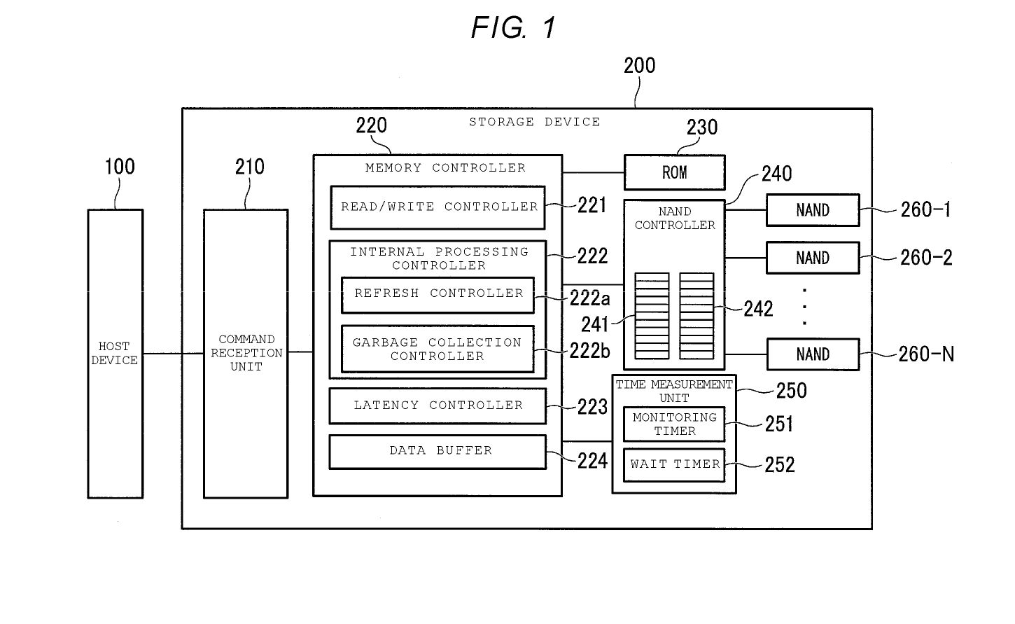

FIG. 1 is a diagram illustrating an example of a host device 100 and a storage device 200 according to a first embodiment. The host device 100 and the storage device 200 are connected to each other using, for example, a serial advanced technology attachment (SATA) interface, a serial attached SCSI (Small Computer System Interface) (SAS) interface, a PCI express (PCIe) interface, or a non-volatile memory host controller interface (NVM Express) (NVMe).

First, the host device 100 will be described. The host device 100 is an example of an “external device” located outside the storage device 200. The host device 100 means a device to which the storage device 200 is connected. The host device 100 is, for example, an information processing device such as a server device or a personal computer. For example, the host device 100 divides a storage space of the storage device 200 into a plurality of logical areas. The host device 100 assigns different logical addresses to the plurality of logical areas. In a case where the host device 100 uses key information instead of the logical address, in the following description, a “logical address” may be read as “key information”.

In a case where it is intended to write data (hereinafter, referred to as “host write data”) into the storage device 200, the host device 100 transmits a write command to the storage device 200. A “command” means an instruction to cause a computer (for example, storage device 200) to execute targeted processing. The “command” in the present specification is not limited to an instruction transmitted by the host device 100, but may include an instruction generated inside the storage device 200 based on an instruction received from the host device 100 and an instruction relating to internal processing (described below) of the storage device 200. The “command” may be understood as an “instruction”, “order”, “signal”, and the like. A “write command” is a command including information indicating a write destination of host write data (for example, write destination logical address).

On the other hand, in a case where it is intended to read data written in the storage device 200, the host device 100 transmits a read command to the storage device 200. A “read command” is a command including information (for example, a read destination logical address) indicating a read destination of data to be read by the host device 100 (hereinafter, referred to as “host read data”). In a case where it is intended to erase at least a portion of data written in the storage device 200, the host device 100 transmits an erase command to the storage device 200. An “erase command” is a command for designating an area in which data to be erased is written.

Next, the storage device 200 will be described. The storage device 200 is a storage device such as the SSD. For example, the storage device 200 is installed in a server device such as a data center. However, the storage device 200 may be a storage device equipped in or mounted on a personal computer or the like. For example, the storage device 200 may be a universal serial bus (USB) memory, an SD (registered trademark) card, or the like.

As illustrated in FIG. 1, the storage device 200 includes, for example, a command reception unit 210, a memory controller 220, a read only memory (ROM) 230, a NAND controller 240, a time measurement unit 250, and NANDs 260-1 to 260-N.

The command reception unit 210, the memory controller 220, the NAND controller 240, and the time measurement unit 250 are implemented by a processor such as a central processing unit (CPU) of the storage device 200 executing a program stored in program memory. However, some or all of these functional units may be implemented in hardware (for example, circuit) such as a large scale integration (LSI) circuit, an application specific integrated circuit (ASIC), or a field-programmable gate array (FPGA). The command reception unit 210, the memory controller 220, the ROM 230, the NAND controller 240, and the time measurement unit 250 may be configured as a system on a chip (SoC) or may be divided into a plurality of chips.

In FIG. 1, the command reception unit 210, the NAND controller 240, and the time measurement unit 250 are not provided in the memory controller 220 for convenience of description, but embodiments are not limited thereto, and functions of the command reception unit 210, the NAND controller 240, and the time measurement unit 250 may be provided in the memory controller 220. Here, the “control unit” referred to in the present specification includes at least the memory controller 220, the NAND controller 240, and the time measurement unit 250. Although the NAND controller 240 is described herein as controlling the plurality of NANDs 260-1 to 260-N, a plurality of NAND controllers 240 corresponding to the plurality of NANDs 260-1 to 260-N may exist. In the following description, the NANDs 260-1 to 260-N are simply referred to as a NAND 260 in a case where the NANDs 260-1 to 260-N are not distinguished from each other. In the following, these functional units will be described.

First, the command reception unit 210 will be described. The command reception unit 210 receives a command from the host device 100. The read command, the write command, then erase command, and the like are representative examples of command types to be received by the command reception unit 210, but the embodiments are not limited thereto. The command reception unit 210 determines a type of a received command based on information included in the received command. For example, in a case where it is determined that the received command is a read command or a write command, the command reception unit 210 sends the received command to a read/write controller 221 in the memory controller 220. Determining the type of the received command may be performed by the memory controller 220 instead of the command reception unit 210.

In a case where processing requested by the received command (hereinafter, referred to as “command processing”) is completed, the command reception unit 210 transmits a completion report indicating that command processing is completed (hereinafter, simply referred to as “completion report”) to the host device 100. The completion report is a predetermined signal which corresponds to the completion of command processing. For that reason, the completion report may be read as a “predetermined signal”.

The completion report may be generated by the command reception unit 210, or the command reception unit 210 may transmit a completion report generated by a latency controller 223 or another functional unit within the memory controller 220. The command reception unit 210 may be referred to as a “transceiver”. Processing of the command reception unit 210 relating to latency adjustment will be described later.

Next, the memory controller 220 will be described. The memory controller 220 includes, for example, the read/write controller 221, an internal processing controller 222, the latency controller 223, and a data buffer 224.

The read/write controller 221 receives the read command and the write command, which are transmitted from the host device 100, through the command reception unit 210. In a case where the received command is the read command, the read/write controller 221 causes the NAND controller 240 to perform read of host read data from the NAND 260. The host read data that is read from the NAND 260 by the NAND controller 240 is temporarily stored in the data buffer 224. The read/write controller 221 transmits the host read data stored in the data buffer 224 to the host device 100 through the command reception unit 210. In a case where transmitting of the host read data to the host device 100 has completed, the read/write controller 221 causes the command reception unit 210 to transmit a completion report indicating that processing requested by the read command is completed to the host device 100.

In a case where the received command is a write command, the read/write controller 221 temporarily stores host write data accompanied by the write command in the data buffer 224 which is used as a write cache. The read/write controller 221 causes the NAND controller 240 to write host write data into the NAND 260. In a case where write of host write data into the NAND 260 has completed, the read/write controller 221 causes the command reception unit 210 to transmit a completion report indicating that processing requested by the write command is completed to the host device 100.

The internal processing controller 222 includes, for example, a refresh controller 222a and a garbage collection controller 222b. “Internal processing” as used in the present specification means internal processing of the storage device 200 that is not based on a command from the host device 100. For example, internal processing means processing for the NAND 260 which is activated and executed by a program such as software and firmware for controlling the storage device 200. Such internal processing includes, for example, refresh and/or garbage collection to be described in the following. However, internal processing is not limited to refresh and garbage collection.

The “refresh” means rewriting of data, which is written in a certain area in the NAND 260, into another area in the NAND 260 or in the same area as an area, which is used before refresh, in the NAND 260. For example, refresh is performed to prevent additional occurrence of errors before an error correction limit by an error correction code is exceeded. The refresh controller 222a controls a refresh operation for the NAND 260. The refresh controller 222a monitors a block state for each block (for example, logical block) of the NAND 260. In a case where the block satisfies a predetermined condition (for example, in a case where the number of occurrences of the error relating to data stored in the block exceeds a predetermined number or in a case where matters that stress accompanied by read disturb for memory cells provided in the block acts more than a predetermined amount are detected), the refresh controller 222a executes refresh which targets the block concerned.

The “garbage collection” is processing of moving data (for example, valid data) other than unnecessary data (for example, invalid data) to a writable area in the NAND 260 and releasing the source area in the NAND 260, in which unnecessary data is written, in order to make it possible to reuse it. The garbage collection controller 222b controls a garbage collection operation for the NAND 260. The garbage collection controller 222b executes garbage collection, for example, in a case where the number of free blocks that can be used as a data write destination becomes less than a fixed number.

The latency controller 223 controls transmission timing of the completion report with respect to a command received from the host device 100 so as to control latency experienced by the host device 100. The latency controller 223 will be described later.

The data buffer 224 is, for example, a volatile memory. The data buffer 224 may include a write buffer (not illustrated) used for write and a read buffer (not illustrated) used for read, and may further include a buffer used for internal processing. The data buffer 224 temporarily stores host write data accompanied by the write command. The data buffer 224 temporarily stores host read data which is read from the NAND 260 by the read/write controller 221. Furthermore, the data buffer 224 temporarily stores read data which is read from the NAND 260 by the refresh controller 222a, read data which is read from the NAND 260 by the garbage collection controller 222b, and the like. Furthermore, various management data is stored in the data buffer 224. An example of the management data is an address conversion table to be described later.

The ROM 230 is an example of a nonvolatile memory. The ROM 230 stores management data described above, software, and firmware. Various management data, software, and firmware stored in the ROM 230 are loaded on the data buffer 224 to be used. The ROM 230 is, for example, an erasable programmable read only memory (EPROM) or an electrically erasable programmable read-only memory (EEPROM).

The NAND controller 240 controls the NAND 260. The NAND controller 240 includes, for example, a queue 241 and a sequencer 242.

A plurality of commands relating to the NAND 260 are stored in the queue 241. The command stored in the queue 241 may be a command received by the command reception unit 210 or a command generated by the memory controller 220 based on the command received by the command reception unit 210. Commands supplied from the read/write controller 221 and the internal processing controller 222 (for example, refresh controller 222a and garbage collection controller 222b) are stored in the queue 241. The plurality of commands stored in the queue 241 are converted into instructions for the NAND 260 by the NAND controller 240 in the order of commands being stored in the queue 241 and processed by the sequencer 242.

The sequencer 242 controls the operation of the NAND 260 in accordance with the instruction issued to the NAND 260. The sequencer 242 executes processing (read, write, erase, and the like for the NAND 260) based on the command supplied from the read/write controller 221 and the internal processing controller 222 (for example, refresh controller 222a and garbage collection controller 222b).

The time measurement unit 250 includes a monitoring timer 251 and a wait timer 252. In the first embodiment, for convenience of explanation, the monitoring timer 251 and the wait timer 252 are described as two different timers, but one timer may have both functions of the monitoring timer 251 and the wait timer 252. The functions of the monitoring timer 251 and the wait timer 252 will be described later.

The NAND 260 is an example of a “nonvolatile memory chip”. Each NAND 260 includes, for example, a plurality of NAND flash memory chips. The nonvolatile memory chip is not limited to the NAND flash memory, but may be a NOR flash memory, a magnetoresistive random access memory (MRAM), or may be any other type of memory chip.

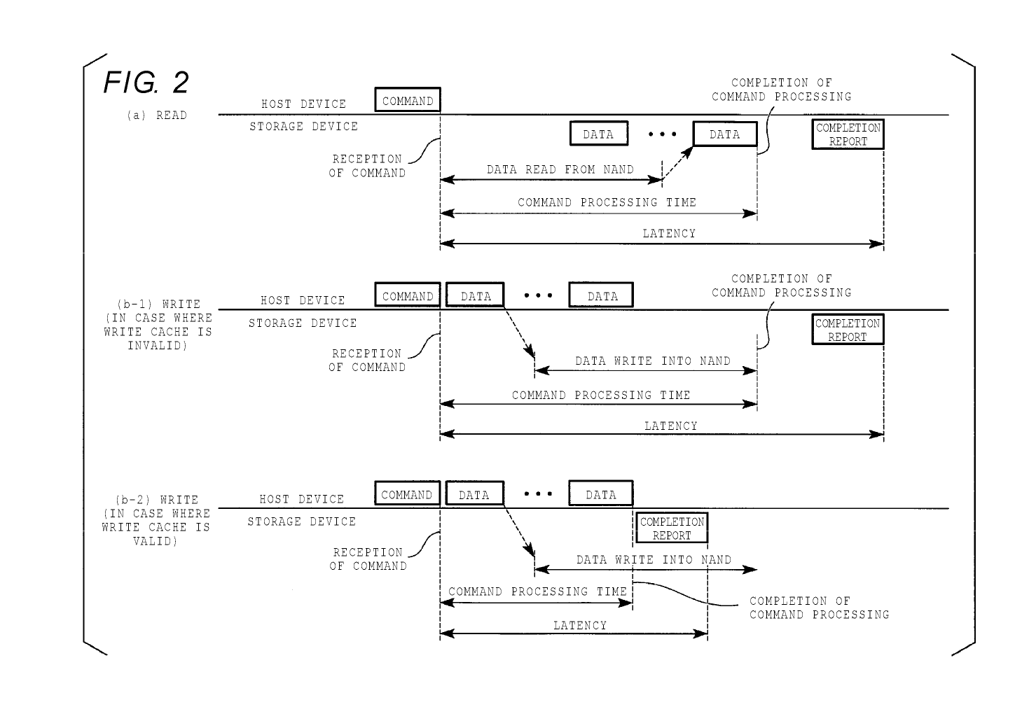

Here, several terms used in the present specification are defined. FIG. 2 is a diagram illustrating an example of a flow of command processing according to the first embodiment.

The “reception” of the command means that a command transmitted by the host device 100 is received by the command reception unit 210 of the storage device 200. For example, it means that in a case of serial advanced technology attachment (SATA), the host device 100 transmits a frame information structure (FIS) to the storage device 200 indicating that the command is stored in a host-to-device register (Reg HD) and the storage device 200 receives the FIS transmitted by the host device 100. Reception of a command for a case of the read command and a case of the write command are the same.

The “completion” of command processing in read means that all host read data designated by the read command is read from the NAND 260 and transmitted to the outside of the storage device 200 (for example, transmitted to the host device 100), as illustrated in (a) of FIG. 2. However, the “completion” of command processing in read does not include transmitting a completion report indicating that the command processing in read is completed to the host device 100.

The “completion” of command processing in write differs depending on whether a write cache is valid or invalid in the storage device 200. As illustrated in (b-1) of FIG. 2, in a case where the write cache is invalid, the “completion” of command processing in write means that all host write data requested to be written by the write command is written in the NAND 260. Specifically, as described above, host write data is temporarily stored in the data buffer 224 first after being received by the command reception unit 210 under control of the read/write controller 221. Host write data is written from the data buffer 224 to the NAND 260 under control of the memory controller 220 and the NAND controller 240. In this case, the memory controller 220 updates the address translation table. The address conversion table is a table in which a logical address of the write destination where host write data is written and a physical address to which host write data is written are associated with each other. In a case where host write data is stored in the data buffer 224 from the command reception unit 210, the memory controller 220 updates the physical address, which corresponds to host write data, of the address conversion table with a physical address of the data buffer 224. Next, in a case where host write data is written from the data buffer 224 to the NAND 260, the memory controller 220 updates the physical address, which corresponds to host write data, of the address translation table with the physical address of the NAND 260. The “completion” of command processing in write means, for example, that the physical address, which corresponds to host write data, of the address translation table is updated with the physical address of the NAND 260. However, the “completion” of command processing in write does not include transmitting a completion report indicating that command processing in write is completed to the host device 100.

As illustrated in (b-2) of FIG. 2, in a case where the write cache is valid, the “completion” of command processing in write means that all host write data requested to be written by the write command is received in the storage device 200. That is, it does not mean that host write data requested to be written by the write command is written in the NAND 260. For example, when host write data is received by the command reception unit 210 and temporarily stored in the data buffer 224 used as the write cache, the memory controller 220 determines that command processing in write is “completed”. In this case, the “completion” of command processing in write may mean, for example, that the physical address, which corresponds to host write data, of the address translation table is updated with the physical address of the data buffer 224. Similarly, as in the case where the write cache is invalid, the “completion” of command processing in write does not include transmitting a completion report to the host device 100 indicating that command processing in write is completed.

The “command processing time” means the time from when a command is received by the command reception unit 210 to when command processing is completed. In this sense, the “command processing time” for the case of the read command is the same as that for the case of the write command.

“Latency” means the time from when a command is received by the command reception unit 210 to when a completion report, which corresponds to the command, is transmitted from the storage device 200 with respect to the host device 100. That is, “latency” is the total time of the command processing time and the time from completion of command processing to end of the completion report transmission. According to these meanings, “latency” for the case of the read command and is the same as that for the case of the write command.

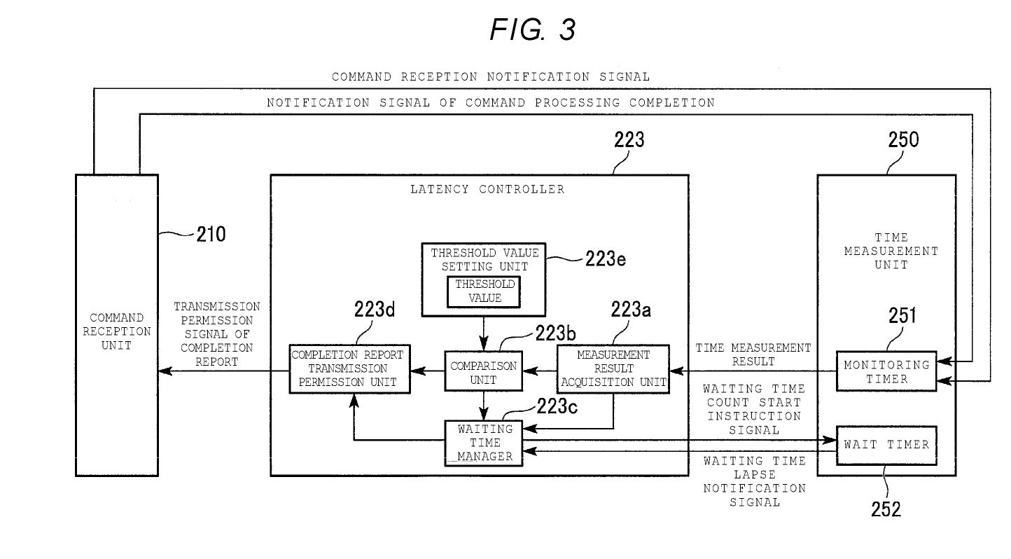

Next, functions of the command reception unit 210, the time measurement unit 250, and the latency controller 223 relating to latency adjustment will be described. FIG. 3 is a diagram illustrating an example of the command reception unit 210, the time measurement unit 250, and the latency controller 223.

In a case where a predetermined command is received, the command reception unit 210 transmits a command reception notification signal to the monitoring timer 251 of the time measurement unit 250. The “predetermined command” is a command which becomes a latency adjustment target to be described later. In the first embodiment, the read command and the write command are each an example of “predetermined command”, but other commands may correspond to the “predetermined command”. On the other hand, in the first embodiment, for example, an inquiry command for requesting general information relating to the storage device 200 does not correspond to the “predetermined command”.

In a case where command processing requested by the predetermined command is completed, the command reception unit 210 further receives a signal indicating that the command processing is completed from the memory controller 220. In a case where a signal indicating that command processing is completed is received from the memory controller 220, the command reception unit 210 transmits a notification signal of command processing completion to the monitoring timer 251. The notification signal of command processing completion may be directly transmitted from the memory controller 220 to the monitoring timer 251 instead of the command reception unit 210.

The monitoring timer 251 is a timer for measuring the command processing time. When a command reception notification signal is received from the command reception unit 210, the monitoring timer 251 starts time measurement. When the notification signal of command processing completion is received from the command reception unit 210, the monitoring timer 251 ends the time measurement. When the time measurement is ended, the monitoring timer 251 stores a measurement result (hereinafter, referred to as “time measurement result”) of the time from reception of the command reception notification signal to reception of the notification signal of command processing completion in the storing unit of the time measurement unit 250. The monitoring timer 251 may be, for example, a timer which is set to 0 at the start of measurement, counts up until the end of measurement, stops counting at the end of measurement, and outputs a count value at the end of measurement as the measurement time, or may be a timer for calculating a measurement time from a difference between the time at the start of the measurement and the time at the end of the measurement.

In the first embodiment, the monitoring timer 251 notifies the latency controller 223 of information indicating the measurement time from the reception of the command reception notification signal to the reception of the notification signal of command processing completion, as the time measurement result of command processing. Instead of the notification as described above, the monitoring timer 251 may output information indicating the time at the start of the measurement and the time at the end of the measurement to the latency controller 223, as the time measurement result of command processing. In this case, the time between the reception of the command reception notification signal and the reception of the notification signal of command processing completion is calculated by the latency controller 223.

The wait timer 252 is a timer for detecting a lapse of a waiting time for delaying transmission of the completion report (hereinafter, simply referred to as “waiting time”) with respect to the completion time of command processing. For example, the “waiting time” is the time from when command processing is completed to when transmission permission of the completion report is given. The waiting time is set by the latency controller 223. The wait timer 252 starts counting based on a count start instruction signal to instruct the start of counting the waiting time issued from the latency controller 223. After the lapse of the waiting time set by the latency controller 223, the wait timer 252 transmits a waiting time lapse notification signal, which informs the lapse of the waiting time, to the latency controller 223. The wait timer 252 may be a timer which is set to 0 at the start of counting, counts up to the result of the waiting time, and stops counting at the lapse of the waiting time and may be a timer which is set to the waiting time at the start of counting, counts down to the lapse of the waiting time, and stops counting at the lapse of the waiting time (that is, counter value is 0).

The latency controller 223 includes a measurement result acquisition unit 223a, a comparison unit 223b, a waiting time manager 223c, a completion report transmission permission unit 223d, and a threshold value setting unit 223e.

The measurement result acquisition unit 223a acquires, for example, a time measurement result by receiving a time measurement result notification from the monitoring timer 251. Instead of receiving the measurement result notification, the measurement result acquisition unit 223a may acquire the time measurement result by reading the measurement result stored in the monitoring timer 251 based on a predetermined trigger signal (for example, a measurement end notification signal transmitted from monitoring timer 251). The measurement result acquisition unit 223a obtains the command processing time based on the time measurement result acquired from the monitoring timer 251. For example, the measurement result acquisition unit 223a acquires the measurement time from reception of the command reception notification signal measured by the monitoring timer 251 to reception of the notification signal of the command processing completion, as the command processing time. Instead of receiving the measurement result, the measurement result acquisition unit 223a may obtain the command processing time by calculating the time from the reception of the command reception notification signal to the reception of the notification signal of command processing completion, as the time between the command processing time and the command processing time, based on information indicating the time at the start of measurement start and the time at the end of measurement, which are received from the monitoring timer 251. The measurement result acquisition unit 223a sends the acquired command processing time to the comparison unit 223b and the waiting time manager 223c.

The comparison unit 223b compares the command processing time acquired by the measurement result acquisition unit 223a with a threshold value held by the threshold value setting unit 223e. The threshold value is a threshold value for determining whether or not to wait for the waiting time until the completion report is transmitted. The threshold value may be referred to as “latency target value”. In a case where the command processing time is equal to or greater than the threshold value, the comparison unit 223b sends a signal indicating that the command processing time is equal to or greater than the threshold value to the completion report transmission permission unit 223d. On the other hand, in a case where the command processing time is smaller than the threshold value, the comparison unit 223b sends a signal indicating that the command processing time is smaller than the threshold value to the waiting time manager 223c.

In a case where the signal indicating that the command processing time is smaller than the threshold value is received from the comparison unit 223b, the waiting time manager 223c calculates the difference between the command processing time and the threshold value and determines the waiting time during which the transmission of the completion report by the command reception unit 210 is delayed. For example, the waiting time manager 223c determines a length of the waiting time based on the difference between the command processing time and the threshold value. For example, the waiting time manager 223c determines a longer waiting time as the difference between the command processing time and the threshold value becomes larger. In the first embodiment, the waiting time manager 223c determines the time substantially the same as the difference between the command processing time and the threshold value as the length of the waiting time. The waiting time manager 223c sets the determined waiting time in the wait timer 252. The waiting time manager 223c transmits a count start instruction signal to the wait timer 252 so as to start measuring the remaining time of the waiting time. The waiting time manager 223c receives a waiting time lapse notification signal from the wait timer 252. In a case where the waiting time lapse notification signal is received from the wait timer 252, the waiting time manager 223c sends a signal indicating that the waiting time is elapsed to the completion report transmission permission unit 223d. The length of the waiting time is not limited to the difference between the command processing time and the threshold value, but maybe determined by selecting one waiting time from a plurality of waiting times which are set in advance.

In a case where a signal indicating that the command processing time is greater than or equal to the threshold value is received from the comparison unit 223b, the completion report transmission permission unit 223d transmits a transmission permission signal of the completion report to the command reception unit 210. In a case where the signal indicating that the waiting time is elapsed is received from the waiting time manager 223c, the completion report transmission permission unit 223d transmits the transmission permission signal of the completion report to the command reception unit 210. The transmission permission signal is an example of an instruction to “transmit a completion report to the command reception unit”.

In the first embodiment, even in a case where command processing requested by the predetermined command is completed, the command reception unit 210 does not send a command completion report with respect to the host device 100 as long as the transmission permission signal is not received from the completion report transmission permission unit 223d. In a case where the transmission permission signal is received from the completion report transmission permission unit 223d, the command reception unit 210 transmits the command completion report to the host device 100. The command reception unit 210 may receive the waiting time lapse notification signal from the wait timer 252 instead of receiving the transmission permission signal from the waiting time manager 223c. In this case, the command reception unit 210 may transmit the command completion report to the host device 100 in a case where the waiting time lapse notification signal is received from the wait timer 252.

The threshold value setting unit 223e sets the threshold value described above used for determining whether or not to wait for the waiting time before the completion report. The threshold value setting unit 223e holds the set threshold value, for example, in the storage area in the threshold value setting unit 223e. For example, the threshold value setting unit 223e extracts a plurality of commands (for example, 100,000 commands) as samples from a plurality of commands received by the command reception unit 210 in a predetermined period (for example, 24 hours). The extraction of commands may be based on a predetermined condition or may be performed at random. The threshold value setting unit 223e sets the threshold value based on the command processing time of the plurality of commands extracted as samples. In the first embodiment, the threshold value setting unit 223e calculates an average value of the command processing times of the plurality of commands extracted as the samples, based on the command processing time of each of the plurality of commands extracted as samples. The threshold value setting unit 223e sets the average value of the calculated command processing time as a threshold value. However, the predetermined period is not limited to 24 hours and can be set to any length of time. In the first embodiment, “a plurality of commands extracted as samples” is an example of “a plurality of commands received in a predetermined period”. However, the “a plurality of commands received in a predetermined period” is not limited to the example described above, and may be all commands received in the predetermined period.

In the first embodiment, the threshold value setting unit 223e updates the threshold value, for each certain period (for example, 24 hours), based on the command processing time of the plurality of commands extracted as samples from the plurality of commands received by the command reception unit 210 during at least the latest period. The expression “based on the command processing time of the plurality of commands received by the command reception unit 210 during at least the latest period” may correspond to a case of being based only on the command processing time of the plurality of commands received by the command reception unit 210 during the latest period, and may include a case of being based on the command processing time of one or more commands received earlier than the plurality of commands received by the command reception unit 210 during the latest period, in addition to the plurality of commands. For example, in a case where it is intended to update the threshold value every 24 hours, the threshold value setting unit 223e may update the threshold value based only on the command processing time of the command received during the latest 24 hours, or may update the threshold value based on the command processing time of the command received during a fixed time period (for example, the latest 48 hours) which includes the latest 24 hours. Also, the predetermined period is not limited to 24 hours, and any time period can be set. In the first embodiment, “a plurality of commands extracted as samples” is an example of “a plurality of commands received during the latest period”. However, the “a plurality of commands received during the latest period” is not limited to the above example, and may be all the commands received during the latest period.

For example, the threshold value maybe given an initial value in advance and may be appropriately updated thereafter. Further, the updated threshold value may be stored in, for example, the NAND 260. In this case, even when power of the storage device 200 is interrupted, the updated threshold value may be read from the NAND 260 and used when the storage device 200 is next powered on.

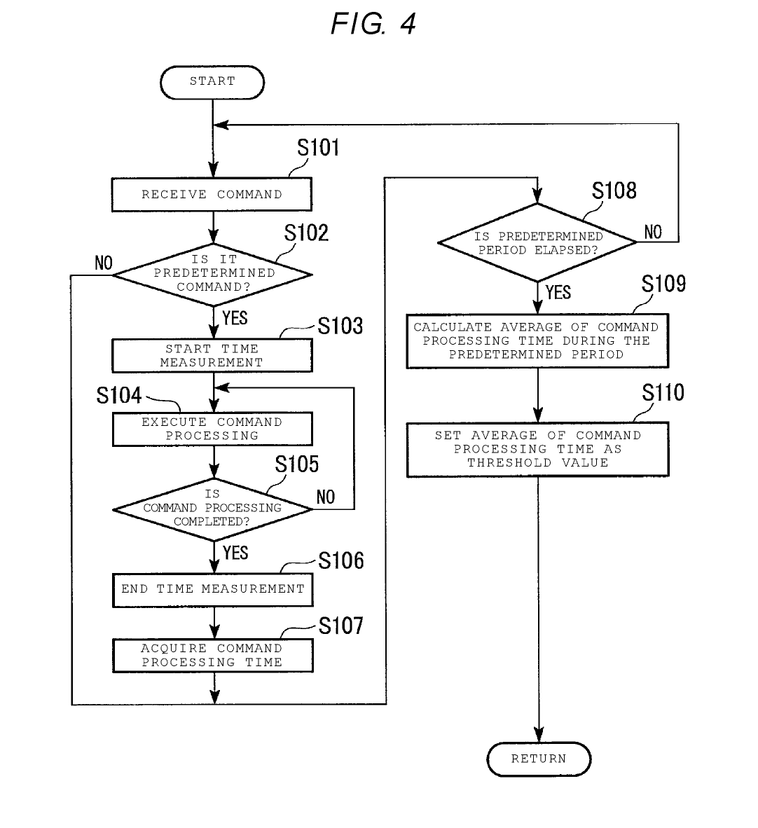

Next, an example of a flow of processing of the storage device 200 of the first embodiment will be described. The flow of processing of the storage device is roughly divided into (1) threshold value setting processing and (2) latency adjustment processing based on the set threshold value. For that reason, two processing described above will be described separately. FIG. 4 is a flowchart illustrating an example of a flow of threshold value setting processing of the storage device 200.

First, the command reception unit 210 receives a command from the host device 100 (S101). The command reception unit 210 determines a type of the received command (S102). In a case where it is determined that the received command is not a predetermined command (for example, read command or write command) (NO in S102), the command reception unit 210 proceeds to processing of S108.

In a case where it is determined that the received command is the predetermined command (YES in S102), the command reception unit 210 transmits the command reception notification signal to the monitoring timer 251. With this, the monitoring timer 251 starts time measurement (S103). Next, the memory controller 220 receives a command transmitted by the host device 100 through the command reception unit 210 and executes the command processing requested by the command (S104). Any of processing of S103 or processing of S104 may be started first or processing of S103 and S104 may be started substantially at the same time.

Until processing of the received command is completed (NO in S105), the memory controller 220 continues command processing. When it is determined that command processing is completed (YES in S105), the memory controller 220 sends a signal indicating that command processing is completed to the command reception unit 210. In a case where a signal indicating that command processing is completed is received, the command reception unit 210 transmits a notification signal of command processing completion to the monitoring timer 251. With this, the monitoring timer 251 ends the time measurement (S106). Next, the measurement result acquisition unit 223a of the latency controller 223 acquires a time measurement result from the monitoring timer 251 and obtains command processing time based on the acquired time measurement result (S107).

The storage device 200 repeatedly performs processing of S101 to S107 for a predetermined period (for example, 24 hours) (NO in S108). In a case where it is determined that the predetermined period is elapsed (YES in S108), the storage device 200 proceeds to next processing. That is, the threshold value setting unit 223e of the latency controller 223 calculates the average value of the command processing times of the plurality of commands received by the command reception unit 210 in a predetermined period (for example, during the latest period) (S109). The threshold value setting unit 223e sets the average value of the calculated command processing time as a threshold value (S110).

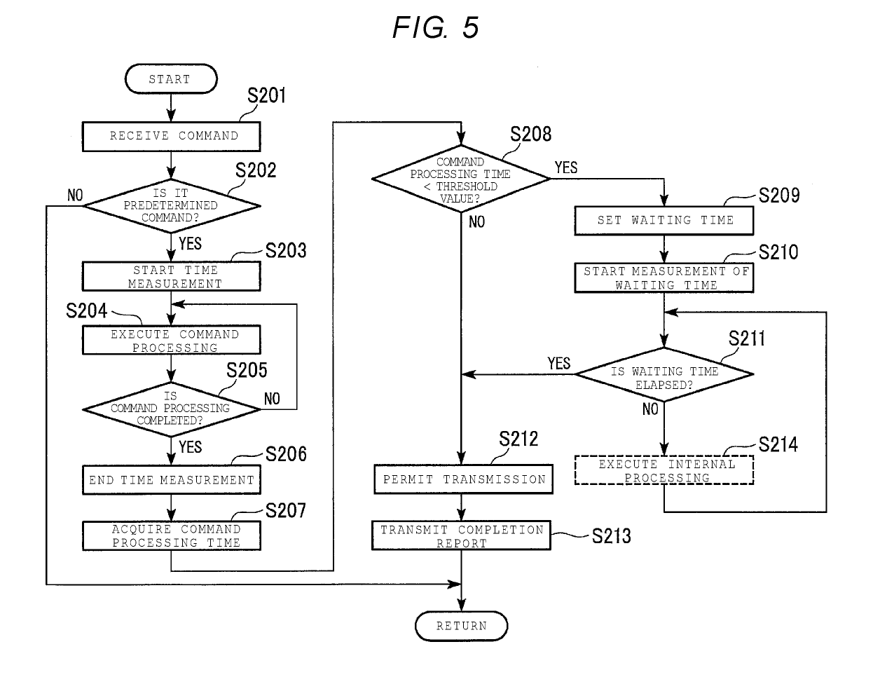

FIG. 5 is a flowchart illustrating an example of a flow of processing of the storage device 200 accompanied by latency adjustment. First, the command reception unit 210 receives a command from the host device 100 (S201). The command reception unit 210 determines a type of the received command (S202). In a case where it is determined that the received command is not the predetermined command (for example, a read command or a write command) (NO in S202), the command reception unit 210 ends processing of the flow.

In a case where it is determined that the received command is the predetermined command (YES in S202), the command reception unit 210 transmits the command reception notification signal to the monitoring timer 251. With this, the monitoring timer 251 starts time measurement (S203). Next, the memory controller 220 receives the command transmitted by the host device 100 through the command reception unit 210 and executes command processing requested by the command (S204). Any of processing of S203 or processing of S204 may be started first or processing of S203 and S204 may be started substantially at the same time.

Until processing of the received command is completed (NO in S205), the memory controller 220 continues command processing. When it is determined that command processing is completed (YES in S205), the memory controller 220 sends a signal indicating that command processing is completed to the command reception unit 210. In a case where the signal indicating that command processing is completed is received, the command reception unit 210 transmits a notification signal of command processing completion to the monitoring timer 251. With this, the monitoring timer 251 ends the time measurement (S206). Next, the measurement result acquisition unit 223a of the latency controller 223 acquires a time measurement result from the monitoring timer 251 and obtains command processing time based on the acquired time measurement result (S207).

Next, the comparison unit 223b compares the command processing time obtained by the measurement result acquisition unit 223a with the threshold value held by the threshold value setting unit 223e (S208). In a case where it is determined that the command processing time is equal to or greater than the threshold value (NO in S208), the comparison unit 223b sends a signal indicating that the command processing time is equal to or greater than the threshold value to the completion report transmission permission unit 223d. In a case where the completion report transmission permission unit 223d receives the signal indicating that the command processing time is equal to or greater than the threshold value from the comparison unit 223b, the completion report transmission permission unit 223d transmits a transmission permission signal of completion report to the command reception unit 210 (S212). In a case where the transmission permission signal of completion report is received, the command reception unit 210 transmits a completion report to the host device 100 (S213). Processing in a case where the determination result in S208 is NO is an example of a “first control operation”.

On the other hand, in a case where it is determined that the command processing time is smaller than the threshold value (YES in S208), the comparison unit 223b transmits a signal indicating that the command processing time is smaller than the threshold value to the waiting time manager 223c. The waiting time manager 223c determines the waiting time based on the difference between the command processing time and the threshold value and sets the determined waiting time in the wait timer 252 (S209). Furthermore, the waiting time manager 223c transmits a count start instruction signal to the wait timer 252. With this, the wait timer 252 starts measuring the remaining time of the waiting time (S210).

In a case where it is determined that the waiting time is elapsed (YES in S211), the wait timer 252 transmits a waiting time lapse notification signal to the waiting time manager 223c. In a case where the waiting time lapse notification signal is received, the waiting time manager 223c transmits the transmission permission signal of completion report to the completion report transmission permission unit 223d (S212). In a case where the transmission permission signal of completion report is received, the command reception unit 210 transmits a completion report to the host device 100 (S213). Processing in a case where the determination result in S208 is YES is an example of a “second control operation” which is different from the first control operation. With this, in a case where the command processing time is shorter than the threshold value, awaiting time with respect o the transmission of the completion report is provided so that latency is adjusted.

Here, the internal processing controller 222 may execute, for example, internal processing of the storage device 200 not based on the command from the host device 100 (S214) until the waiting time elapses (NO in S211). For example, the internal processing controller 222 may perform processing of refresh and/or garbage collection during the waiting time. In the first embodiment, the internal processing controller 222 stores one or more commands relating to refresh and/or garbage collection in the queue 241 of the NAND controller 240 during the waiting time. With this, in the queue 241, one or more commands relating to refresh and/or garbage collection are inserted between a plurality of commands relating to reading of host read data and/or writing of write read data. This makes it easier for the commands relating to internal processing to be conducted. Processing of Step S214 is arbitrary and is not indispensable. Although processing of Step S214 may be performed in the waiting time, it may be executed as a result of availability of the queue 241 of the NAND controller 240 irrespective of whether it is a waiting time or not.

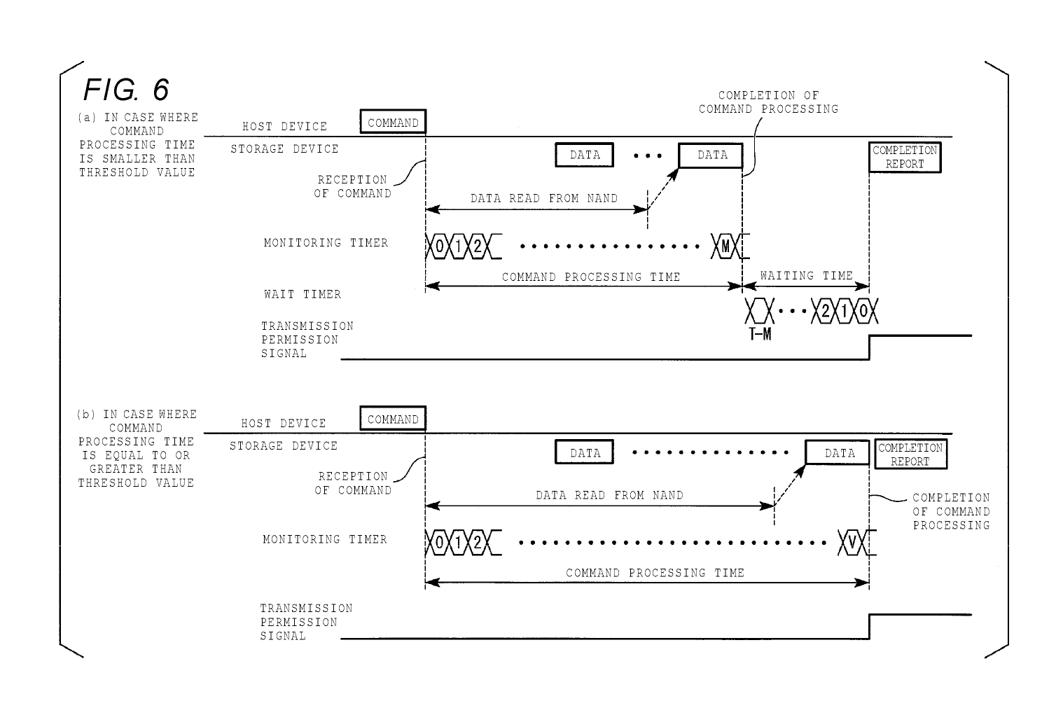

Next, an example of an operation of the storage device 200 of the first embodiment will be described. FIG. 6 is a diagram illustrating an example of a read operation of the storage device 200. FIG. 6 illustrates an example in which a timer that counts down the waiting time is used as the wait timer 252.

First, a case where the command processing time is smaller than the threshold value will be described with reference to (a) of FIG. 6. When the storage device 200 receives a read command transmitted from the host device 100, the monitoring timer 251 starts time measurement. When all host data designated by the read command is read from the NAND 260 and transmitted to the outside of the storage device 200, command processing is completed. Here, it is assumed that a count value of the monitoring timer 251 at the timing when the command processing is completed is M, the threshold value is T, and M<T. In this case, the waiting time manager 223c sets a value of (T-M) in the wait timer 252. The wait timer 252 starts counting down the count value. When the count value of the wait timer 252 becomes 0, the waiting time manager 223c transmits the transmission permission signal of completion report to the completion report transmission permission unit 223d. As a result, the command reception unit 210 transmits a completion report to the host device 100. According to such an operation, as illustrated in (a) of FIG. 6, it is possible to provide a waiting time corresponding to the difference between the command processing time and the threshold value between command processing completion and transmission start of the completion report.

Next, a case where the command processing time is equal to or greater than the threshold value will be described with reference to (b) of FIG. 6. The operation until command processing is completed is the same as in (a) of FIG. 6. Here, it is assumed that the count value of the monitoring timer 251 at the timing when command processing is completed is V, a threshold value is T, and V>T. In this case, the comparison unit 223b sends a signal indicating that the command processing time is equal to or greater than the threshold value to the completion report transmission permission unit 223d. With this, the completion report transmission permission unit 223d is caused to transmit the transmission permission signal of completion report without waiting the waiting time. With this, the command reception unit 210 transmits the completion report to the host device 100 immediately after the command processing is completed.

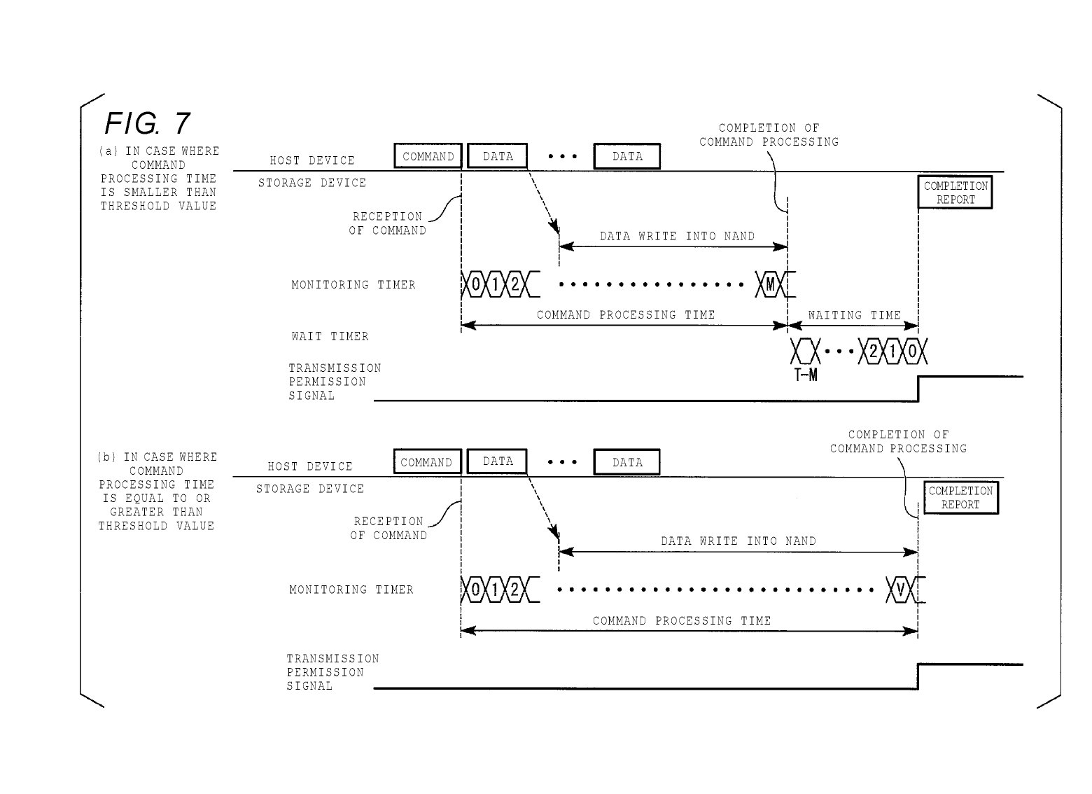

FIG. 7 is a diagram illustrating an example of a write operation of the storage device 200. FIG. 7 illustrates an example in which a timer that counts down the waiting time is used as the wait timer 252. Although an operation in a case where a write cache is invalid will be described in FIG. 7, an operation in a case where a write cache is valid is the same as the operation in the case where the write cache is invalid, except that command processing completion means that all host write data requested to be written by the write command is received in the storage device 200.

First, a case where the command processing time is smaller than the threshold value will be described with reference to (a) of FIG. 7. When the storage device 200 receives a write command transmitted from the host device 100, the monitoring timer 251 starts time measurement. When all data designated by the write command is stored in the NAND 260 (for example, a physical address of an address conversion table corresponding to write data is updated with a physical address of the NAND 260), command processing is completed. Here, it is assumed that a count value of the monitoring timer 251 at the timing when command processing is completed is M, the threshold value is T, and M<T. In this case, the waiting time manager 223c sets the value of (T-M) in the wait timer 252. The wait timer 252 starts counting down the count value. When the count value of the wait timer 252 becomes 0, the waiting time manager 223c transmits the transmission permission signal of completion report to the completion report transmission permission unit 223d. As a result, the command reception unit 210 transmits a completion report to the host device 100. According to such an operation, as illustrated in (a) of FIG. 7, it is possible to provide the waiting time corresponding to the difference between the command processing time and the threshold value between command processing completion and transmission start of the completion report.

Next, a case where the command processing time is equal to or greater than the threshold value will be described with reference to (b) of FIG. 7. The operation until command processing is completed is the same as in (a) of FIG. 7. Here, it is assumed that the count value of the monitoring timer 251 at the timing when command processing is completed is V, the threshold value is T, and V>T. In this case, the comparison unit 223b sends a signal indicating that the command processing time is equal to or greater than the threshold value to the completion report transmission permission unit 223d. With this, the completion report transmission permission unit 223d is caused to transmit the transmission permission signal of completion report without waiting the waiting time. With this, the command reception unit 210 transmits the completion report to the host device 100 immediately after the command processing is completed.

According to the configuration described above, it is possible to reduce the variation in latency experienced by the host device 100. Here, a comparative example in which latency is not adjusted is considered. In the storage device 200, internal processing (for example, refresh and/or garbage collection) of the storage device operates in parallel, in addition to command processing requested by the command from the host device 100. For that reason, variation in latency for the host device 100 may occur. On the other hand, a user expects uniform latency.

In the first embodiment, the storage device 200 includes the command reception unit 210 and a control unit. The command reception unit 210 receives a command from the host device 100, and transmits a completion report to the host device 100 in a case where processing requested by the command is completed. In a case where the command processing time from the reception of the command by the command reception unit 210 to the completion of processing is smaller than the threshold value, the control unit causes the command reception unit 210 to transmit completion report with the waiting time after the completion of processing. With this, in a case where the command processing time is short, it is possible to reduce the variation in the latency by delaying transmission of the completion report. As a result, it is possible to improve a satisfaction level of the user.

In the first embodiment, the control unit obtains the command processing time based on the time measurement result obtained from matters measurement is started when the command reception unit 210 receives the command and the measurement is ended when processing is completed. According to such a configuration, it is possible to accurately obtain the command processing time for each command by measuring the time. With this, it is possible to further reduce the variation in latency at a higher level.

In the first embodiment, the control unit determines the length of the waiting time based on the difference between the command processing time and the threshold value. According to such a configuration, it is possible to change the waiting time for each command based on the difference between the command processing time and the threshold value. With this, it is possible to further suppress the variation in latency at a higher level.

In the first embodiment, the control unit sets the threshold value based on the command processing time of the plurality of commands received by the command reception unit 210 in a certain period. According to such a configuration, it is possible to set the threshold value based on an actual operation state of the storage device 200 in a certain period. With this, it is possible to further reduce the variation in latency at a higher level.

In the first embodiment, the control unit sets the average value of the command processing time of the plurality of commands to the threshold value. According to such a configuration, latency for a command of which the processing time is shorter than the average value is lengthened by providing the waiting time. As such, it is possible to effectively reduce the variation in the latency by increasing only latency for the command of which the processing time is shorter than the average value. The control unit may set a median value or a mode value of the command processing time of the plurality of commands, instead of the average value of the command processing time of the plurality of commands, to the threshold value.

In the first embodiment, the control unit updates the threshold value for each period based on the command processing time of the plurality of commands received by the command reception unit 210 during at least the latest period. According to such a configuration, it is possible to set a threshold value in accordance with the latest operation environment of the storage device and/or the latest internal state of the storage device by reflecting the command processing time of the command received by the storage device 200 during the latest period. As a result, it is possible to reduce the variation in latency at a higher level.

In the first embodiment, the same threshold value is used for a predetermined command (for example, a read command and a write command) which becomes a latency adjustment target. However, the threshold value may be a different threshold value for each type of command. That is, different threshold values maybe set for the read command and the write command. In this case, threshold value setting processing of the storage device 200 illustrated in FIG. 4 and processing of the storage device 200 illustrated in FIG. 5 may be performed for each type of command.

Here, in the storage device 200, in a case where a predetermined condition is satisfied inside the storage device 200, internal processing (for example, refresh and/or garbage collection) of the storage device 200 not based on a command from the host device 100 is executed. Such internal processing is generally performed in parallel with command processing from the host device 100, but it may take longer than a response time for the read command and the write command. When such requests for internal processing are accumulated inside the storage device 200 and the accumulated internal processing requests are continuously executed, latency of the read command and the write command may become longer. As a result, latency for the host device 100 may vary significantly.

On the other hand, in the first embodiment, the control unit executes internal processing of the storage device 200 not based on the command from the host device 100 during the waiting time. According to such a configuration, a command relating to internal processing is input to the queue 241 in the waiting time before transmission of the completion report (that is, during the time when the queue 241 of the NAND controller 240 is relatively available). With this, inputting of the commands relating to internal processing to the queue 241 is spread out over time. With this, it is possible to suppress requests for internal processing from being accumulated more than a certain amount within the storage device 200. With this, it is possible to prevent the accumulated requests for internal processing from being executed successively. As a result, it is possible to reduce the variation in latency at a higher level.

### Second Embodiment

Next, a second embodiment will be described. The second embodiment is different from the first embodiment in that the upper limit value and the lower limit value of the threshold value adjustment range are set based on designation by the user. Configurations other than those described below are the same as those in the first embodiment.

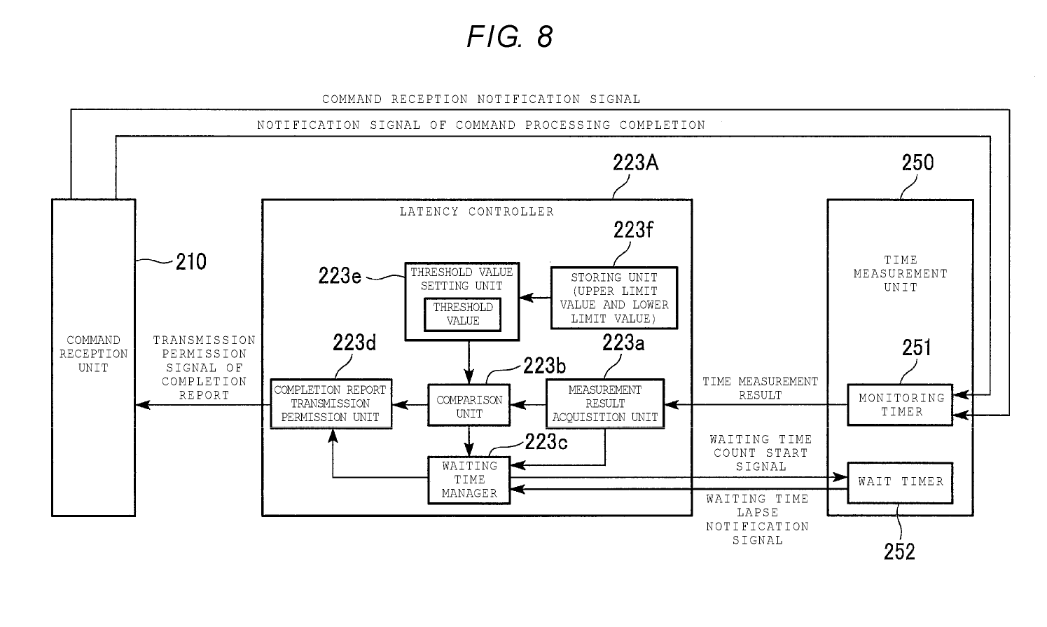

FIG. 8 is a diagram illustrating an example of the command reception unit 210, the time measurement unit 250, and a latency controller 223A of the second embodiment. As illustrated in FIG. 8, the latency controller 223A includes the measurement result acquisition unit 223a, the comparison unit 223b, the waiting time manager 223c, the completion report transmission permission unit 223d, the threshold value setting unit 223e, and a storing unit 223f.

An example of the storing unit 223f is, for example, a parameter storage area of firmware implementing the latency controller 223A. The storing unit 223f stores the upper limit value and the lower limit value of the threshold value which are set by the threshold value setting unit 223e. In the second embodiment, the threshold value setting unit 223e stores the value designated by the user, as the upper limit value and the lower limit value of the threshold value, in the storing unit 223f. That is, the threshold value setting unit 223e receives an instruction of the user to designate the upper limit value and the lower limit value of the threshold value through, for example, the host device 100 and the command reception unit 210, and registers the upper limit value and the lower limit value of the threshold value designated by the user in the storing unit 223f. For example, the upper limit value and the lower limit value of the threshold value are given initial values by software or firmware, and may be changed based on an instruction of the user. The upper limit value and the lower limit value of the threshold value may be set by an internal operation of the latency controller 223A without being based on an instruction of the user.

In the second embodiment, the threshold value setting unit 223e sets the threshold value (similarly as in the first embodiment, threshold value used for determining whether or not to wait for the waiting time until the completion report is transmitted) to be compared with the command processing time within the adjustment range between the upper limit value and the lower limit value of the threshold value designated by the user. For example, the threshold value setting unit 223e extracts a plurality of commands (for example, 100,000 commands) as samples from a plurality of commands received by the command reception unit 210 in a predetermined period (for example, 24 hours). The extraction of the commands maybe based on a predetermined condition or may be performed at random. The plurality of commands extracted as samples maybe only those commands within the range between the upper limit value and the lower limit value. The threshold value setting unit 223e sets the threshold value based on the command processing time of the plurality of commands extracted as samples. In the second embodiment, the threshold value setting unit 223e sets the command processing time, of which value is the largest between the upper limit value and the lower limit value of the threshold value, among the command processing times of the plurality of commands extracted as samples, as a threshold value, based on the command processing time of each of the plurality of commands extracted as samples. In a case where all the command processing times of the plurality of commands extracted as samples fall below the lower limit value, the threshold value setting unit 223e may set the lower limit value as the threshold value. In a case where all the command processing times of the plurality of commands extracted as samples exceed the upper limit value, the threshold value setting unit 223e may set the upper limit value as the threshold value. In the second embodiment, “a plurality of commands extracted as samples” is an example of “a plurality of commands received in a predetermined period”. However, the “a plurality of commands received in a predetermined period” is not limited to the example described above, and may be all commands received in a predetermined period.

In the second embodiment, similarly as in the first embodiment, the threshold value setting unit 223e updates the threshold value every certain period (for example, 24 hours), based on the command processing times of the plurality of commands extracted, as samples, from a plurality of commands received by the command reception unit 210 during at least the latest period. In the second embodiment, “a plurality of commands extracted as samples” is an example of “a plurality of commands received during the latest period”. However, the “plurality of commands received during the latest period” is not limited to the example described above, and may be all the commands received during the latest period.

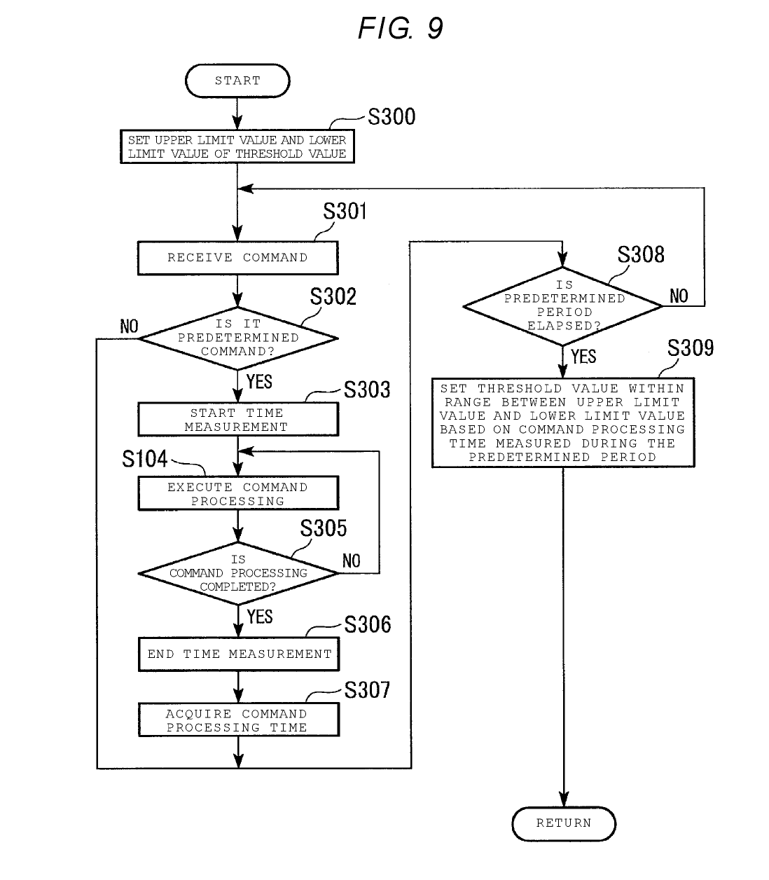

FIG. 9 is a flowchart illustrating an example of a flow of threshold value setting processing of the storage device 200 according to the second embodiment. First, the threshold value setting unit 223e receives an instruction of the user to designate the upper limit value and the lower limit value of the threshold value. In a case where the instruction of the user designating the upper limit value and the lower limit value of the threshold value is received, the threshold value setting unit 223e stores the upper limit value and the lower limit value of the threshold value designated by the user in the storing unit 223f (S300). Next, the storage device 200 performs processing of S301 to S308. Processing of S301 to S308 is substantially the same as processing of S101 to S108 of the first embodiment and thus, redundant description thereof will be omitted here.

The storage device 200 repeatedly performs processing of S301 to S307 for a predetermined period (for example, 24 hours) (NO in S308). In a case where it is determined that the predetermined period is elapsed (YES in S308), the storage device 200 proceeds to next processing. That is, the threshold value setting unit 223e of the latency controller 223A specifies the largest value between the upper limit value and the lower limit value of the threshold value among the command processing times of the plurality of commands received by the command reception unit 210 in a predetermined period (for example, during the latest period) and sets the largest value of the specified command processing time as the threshold value (S309).

According to such a configuration, similarly as in the first embodiment, it is possible to reduce the variation in latency with respect to the host device 100. Furthermore, in the second embodiment, the control unit has an area for storing the upper limit value of the threshold value and sets the threshold value within a range less than or equal to the upper limit value. According to such a configuration, latency is adjusted based on the upper limit value of the threshold value and thus, it is possible to adjust latency in accordance with needs of the user.

In the second embodiment, the control unit stores the value designated by the user as the upper limit value of the threshold value. According to such a configuration, it is possible to adjust latency based on the upper limit value of the threshold value designated by the user. With this, it is possible to further adjust the latency in accordance with needs of the user.

In the second embodiment, the lower limit value is also stored in the storing unit 223f, in addition to the upper limit value. The control unit sets the threshold value within the range between the upper limit value and the lower limit value. According to such a configuration, even in a case where the command processing time of the plurality of commands received during a predetermined period is extremely short, a threshold value according to the lower limit value is set. For that reason, after the lower limit value is set, even in a case where the command processing time becomes longer, it is possible to make change in latency be a fixed level or less.

The storing unit 223f may store only the upper limit value of the threshold value, instead of a case of storing both the upper limit value and the lower limit value of the threshold value. In this case, the threshold value setting unit 223e sets the threshold value within the range equal to or less than the upper limit value of the threshold value. That is, the threshold value setting unit 223e sets the command processing time, of which value is the largest within the range less than or equal to the threshold value, among the command processing times of the plurality of commands extracted as samples, as a threshold value, based on the command processing time of each of the plurality of commands received by the command reception unit 210.

According to at least one embodiment described above, in a case where the command processing time required for processing requested by the command is equal to or more than the threshold value, the first control operation is performed, and in a case where the command processing time is smaller than the threshold value, the second control operation different from the first control operation is performed, so that it is possible to reduce the variation in latency with respect to the host device.

In the following, description on several storage devices and several control methods of the storage devices will be added.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A storage device comprising:
a command reception unit configured for communication with a host device to receive a command from the host device and transmit a completion report to the host device upon completion of processing requested in the command; and
a control unit configured to determine a threshold amount of time to wait after the command reception unit receives the command before causing the command reception unit to transmit the completion report, and to cause the command reception unit to transmit the completion report after waiting a period of time after completion of the processing, if the processing completes before the threshold amount of time has elapsed since reception of the command.

2. The storage device according to claim 1,
wherein the control unit causes the command reception unit to transmit the completion report without waiting, if the processing completes after the threshold amount of time has elapsed since reception of the command.

3. The storage device according to claim 1,
wherein the control unit is configured to determine a difference between the threshold amount of time and the time taken to process the command as the period of time to wait.

4. The storage device according to claim 3,
wherein the control unit is configured to set the threshold amount of time based on the time taken to process a plurality of commands received by the command reception unit during a certain period.

5. The storage device according to claim 3,
wherein the control unit is configured to set the threshold amount of time based on an average time taken to process a plurality of commands received by the command reception unit during a certain period.

6. The storage device according to claim 1, wherein the controller is configured to execute internal processing during the period of time of waiting.

7. The storage device according to claim 6, wherein the internal processing is one of refresh processing and garbage collection processing.

8. The storage device according to claim 1, wherein the command is a read command or a write command.

9. The storage device according to claim 1, wherein the threshold amount of time set differently for read and write commands.

10. A storage device comprising:
a command reception unit configured for communication with a host device to receive a command from the host device, and transmit a completion report to the host device upon completion of processing requested in the command; and
a control unit configured to determine an amount of time taken to complete the processing, perform a first control operation in a case where the amount of time is greater than a threshold value, and to perform a second control operation different from the first control operation in a case where the amount of time is smaller than the threshold value.

11. The storage device according to claim 10,
wherein the control unit is configured to set the threshold value based on the time taken to process a plurality of commands received by the command reception unit during a certain period.

12. The storage device according to claim 10,
wherein the control unit is configured to set the threshold value based on an average time taken to process a plurality of commands received by the command reception unit during a certain period.

13. The storage device according to claim 10,
wherein the first control processing includes causing the command reception unit to transmit the completion report, and the second control processing includes waiting a period of time before causing the command reception unit to transmit the completion report.

14. The storage device according to claim 13, wherein the controller is configured to execute internal processing during the period of time of waiting.

15. The storage device according to claim 14, wherein the internal processing is one of refresh processing and garbage collection processing.

16. The storage device according to claim 10, wherein the command is a read command or a write command.

17. The storage device according to claim 16, wherein the threshold amount of time set differently for read and write commands.

18. A method of controlling a latency of a storage device connected to a host device, comprising:
determining a threshold amount of time to wait after receiving a command from the host device before transmitting a completion report to the host device;
receiving the command from the host;
upon completion of a processing requested in the command, determining an amount of time elapsed since the command was received;
upon determining that the amount of time elapsed is less than the threshold amount of time, waiting for a period of time before transmitting the completion report; and
upon determining that the amount of time elapsed is greater than the threshold amount of time, transmitting the completion report without waiting.

19. The method according to claim 18, further comprising:
executing internal processing during the period of time of waiting.

20. The method according to claim 19, wherein the internal processing is one of refresh processing and garbage collection processing.
